(19) United States
(12) Patent Application Publication
(10) Pub. No.: US 2018/0354440 A1
(43) Pub. Date: Dec. 13, 2018

(54) METHOD AND SYSTEM FOR AUTOMATIC ADJUSTMENT OF AT LEAST ONE PIECE OF EQUIPMENT OF A MOTOR VEHICLE

(71) Applicant: STMicroelectronics (Grand Ouest) SAS, Delarue (FR)

(72) Inventor: Arnaud POULIQUEN, Etival Les Le Mans (FR)

(73) Assignee: STMicroelectronics (Grand Ouest) SAS, Delarue (FR)

(21) Appl. No.: 16/002,654

(22) Filed: Jun. 7, 2018

(30) Foreign Application Priority Data
Jun. 9, 2017 (FR) 1755164

(51) Int. Cl. B60R 21/01; B60N 2/00; B60N 2/02; B60R 16/037; G06K 9/00

(52) U.S. Cl. CPC B60R 21/01; B60N 2/002; B60N 2/0244; B60R 2021/01034; G06K 9/00838; G06K 9/00288; B60R 2021/01286; B60R 16/037

(57) ABSTRACT

An automatic adjustment of a piece of equipment of a motor vehicle is performed in response to detecting the presence of at least one person on at least one seat of the motor vehicle or detecting the absence of a person on a front passenger seat of the motor vehicle. The automatic adjustment of the at least one piece of equipment as a function of the result of the detection.

### PRIORITY CLAIM

This application claims the priority benefit of French Application for Patent No. 1755164, filed on Jun. 9, 2017, the content of which is hereby incorporated by reference in its entirety to the maximum extent allowable by law.

### TECHNICAL FIELD

Various embodiments and implementation of the invention relate to adjustment systems, and more particularly, automatic systems for adjustment intended to equip motor vehicles and allowing adaptive automatic adjustments to be carried out on one or more pieces of equipment of the vehicle in the case of the presence/absence of one or more persons within the passenger compartment of a motor vehicle.

### BACKGROUND

Generally speaking, conventional motor vehicles provide a plurality of controllable adjustments of their internal and external equipment, such as the heights of front seats, the enabling/disabling of airbags associated with the front passenger, or the orientations of interior and/or exterior rear-view mirrors, so that the drivers and passengers of these motor vehicles can manually adjust them in such a manner as to adapt them as far as possible to their particular needs.

Moreover, certain top-end motor vehicles are sometimes configured so as to provide several predefined adjustments and so as to be capable of storing certain adjustments notably set up by the drivers.

However, this always requires manual interventions by the drivers and/or passengers in order to choose the predefined or stored adjustments and this generally requires prior learning with regard to the implementation of these adjustments within these specific motor vehicles.

There thus exists a need to provide a low-complexity technical solution allowing numerous adjustments of certain pieces of equipment for a motor vehicle in such a manner as to adapt to dynamic changes linked notably to the presence or to the absence of one or more persons within the passenger compartment of the motor vehicle, and/or to the physical characteristics of the persons present.

### SUMMARY

According to one aspect, a method is provided for automatic adjustment of at least one piece of equipment of a motor vehicle. The method comprises: detecting the presence of at least one person on at least one seat of the vehicle or of the absence of a person on the front passenger seat of the vehicle, and at least one automatic adjusting of at least one piece of equipment as a function of a result of the detection.

Such a method advantageously allows dynamic adaption to the physical characteristics of the person or persons present in the vehicle taking into account the occupied seat or seats, by the implementation of automatic adjustments adapted to the current occupation configuration of the vehicle.

Thus, the manual interventions of the persons in the vehicle are limited, or even eliminated, and even first-time users can obtain satisfactory adjustments that are adapted to them, without any prior training.

According to one embodiment, if the presence of at least one person on at least one seat of the vehicle is detected, the at least one adjustment comprises an automatic adjustment of an audio configuration of an audio system of the vehicle depending on the seat or seats occupied by the person or persons detected.

According to one embodiment, the automatic adjustment of the audio configuration comprises an adjustment of a reference listening position of an audio system of the vehicle, in such a manner as to place the reference listening position at the center of a region encompassing the seat or seats occupied by the person or persons detected.

Thus, advantageously, all the persons present in the vehicle can receive the best sound possible as a function of their positions (here their seats as occupied in the vehicle).

According to another embodiment, if the presence of at least one person on at least one seat of the vehicle is detected, the method comprises: determining areas of a face and of eyes of the person or persons on the corresponding occupied seat or seats, and wherein the at least one adjusting comprises an automatic adjusting in height of the corresponding occupied seat or seats and/or of the corresponding seat belts.

According to this other embodiment, the automatic adjusting in height comprises, for example, a first adjustment of the height of each corresponding occupied seat, then a second adjustment of the height of each corresponding seat belt.

The first adjustment may, for example, comprise a first adjustment of the height of each corresponding occupied seat so as to render substantially equal the height of the center of the area of the eyes of the corresponding person and a reference height.

The phrase “substantially equal” is understood for example to mean “equal to within a certain tolerance, for example less than 2 cm”.

The second adjustment may, for example, comprise a second adjustment of the height of each corresponding seat belt so as to render substantially equal the height of the corresponding seat belt and the height of the lower limit of the facial area of the corresponding person.

According to yet another embodiment, if the absence of a person on the front passenger seat is detected, the at least one automatic adjusting comprises disabling of the airbag or airbags associated with the front passenger seat.

Such a method advantageously allows the airbags to be automatically disabled if there is no one on the front passenger seat, which is very practical, or even obligatory, in the case of installation of a car-seat referred to as “back to the road” or backward facing on the front passenger seat by virtue of certain regulations (such as, for example, European regulations dating from 2006).

According to yet another embodiment, if the presence of a person on the driver's seat is detected, the method further comprises: determining areas of the face and of the eyes of the person on the driver's seat in such a manner as to determine the current position of the eyes of this person, and wherein the at least one adjusting comprises a third adjustment of rear-view mirrors of the vehicle as a function of the current position of the eyes.

As a variant, the method further comprises performing a facial recognition of the person on the driver's seat, and in the case of a successful facial recognition, the at least one adjusting comprises the third adjustment with stored orientations of the rear-view mirrors of the vehicle associated with the person, and in the case of a failed facial recognition, the at least one adjustment comprises storing current orientations of the rear-view mirrors of the vehicle subsequent to the third adjustment.

Such a method advantageously allows adapted adjustments associated with a stored driver to be automatically applied once this driver is again detected in the driver's seat, which advantageously avoids a manual intervention by the driver.

The third adjustment may, for example, comprise a third adjustment of orientations of the rear-view mirrors of the vehicle as a function of the angular difference between the current position and a reference position.

Accordingly, any given driver can obtain a driving position and a visibility that are adapted with the aid of such a method. Furthermore, this method can follow in real time the variation of the position of the face of the driver and then adjust as a consequence the orientations of the rear-view mirrors, for example interior and exterior, in order to provide a visibility of the rear-view mirrors that is always correctly adjusted.

According to yet another embodiment, the method further comprises: performing a facial recognition of at least one person detected on at least one seat of the vehicle, and in the case of a successful facial recognition, the first adjustment is carried out with the stored seat height or heights associated with the at least one person, the second adjustment is carried out with the stored seat belt height or heights associated with the at least one person, and in the case of a failed facial recognition, the at least one adjustment comprises storing, subsequent to the first adjustment, of the current seat height or heights of each occupied seat of the vehicle and a storing, subsequent to the second adjustment, of the current seat belt height or heights for at least one corresponding seat belt.

According to another aspect, a system is provided for automatic adjustment of at least one piece of equipment of a motor vehicle. This system comprises: means for detecting the presence of at least one person on at least one seat of the vehicle or the absence of a person on the front passenger seat of the vehicle, and means for carrying out at least one automatic adjustment of the at least one piece of equipment as a function of the result of the detection.

According to one embodiment, the means for adjusting comprises an audio adjustment means configured, if the means for detecting detects the presence of at least one person on at least one seat of the vehicle, for automatically adjusting an audio configuration of an audio system of the vehicle depending on the seat or seats occupied by the person or persons detected.

According to one embodiment, the audio adjustment means is configured for automatically adjusting the configuration of the audio system of the vehicle, by an adjustment of a reference listening position of the audio system of the vehicle, in such a manner as to place the reference listening position at the center of a region encompassing the seat or seats occupied by the person or persons detected.

According to another embodiment, the system further comprises, if the means for detecting detects the presence of at least one person on one of the front seats, means for determining areas of the face and of the eyes of the at least one person on the corresponding front seat or seats, and wherein the means for adjusting further comprises means for adjusting seats and of seat belts configured for automatically adjusting the height or heights of the corresponding front seat or seats and of the corresponding front seat belt or seat belts.

According to another embodiment, the means for adjusting seats and seat belts is configured for automatically adjusting the height or heights of the corresponding front seat or seats and of the corresponding front seat belt or seat belts by a first adjustment of the height of each corresponding front seat, and then by a second adjustment of the height of each corresponding front seat belt.

By way of non-limiting example, the means for adjusting seats and seat belts may further be configured for carrying out the first adjustment by a first adjustment of the height of each corresponding front seat so as to render substantially equal the height of the center of the area of the eyes of the corresponding person and a reference height, and carrying out the second adjustment by a second adjustment of the height of each corresponding front seat belt so as to render substantially equal the height of the corresponding front seat belt and the height of the lower limit of the facial area of the corresponding person.

According to yet another embodiment, the means for adjusting further comprises means for adjusting airbags configured, if the means for detecting detects the absence of a person on the front passenger seat, for disabling one or more airbags associated with the front passenger seat.

According to yet another embodiment, the system further comprises means, if the means for detecting detects the presence of a person on the driver's seat, for determining areas of the face and of the eyes of the person on the driver's seat in such a manner as to determine the current position of the eyes of this person, and wherein the means for adjusting further comprises means for adjusting visibility configured for carrying out a third adjustment of the rear-view mirrors of the vehicle as a function of the current position of the eyes.

As a variant, the means for adjusting visibility may comprise a memory configured for storing drivers' profiles, wherein the means for detecting further configured for carrying out a facial recognition of the person detected on the driver's seat using the memory.

In the case of a successful recognition, the means for adjusting visibility may be configured for carrying out the third adjustment with orientations of the rear-view mirrors of the vehicle stored in the memory and associated with the person.

In the case of a recognition failure, the memory may be configured for storing current orientations of the rear-view mirrors of the vehicle subsequent to the third adjustment.

The means for adjusting visibility may, for example, be configured for carrying out the third adjustment by a third adjustment of orientations of the rear-view mirrors of the vehicle as a function of the angular difference between the current position of the eyes and a reference position.

According to another embodiment, the means for detecting is further configured for carrying out a facial recognition of at least one person detected on at least one seat of the vehicle using the memory.

In the case of a successful recognition, the means for adjusting seats and seat belts is configured for carrying out the first adjustment with the height or heights of at least one seat of the vehicle stored in the memory and associated with the at least one person and the second adjustment with the height or heights of at least one seat belt stored in the memory and associated with the at least one person.

In the case of a recognition failure, the memory is configured for storing, subsequent to the adjustment of the seat height, the current seat height or heights of each occupied seat of the vehicle, and storing, subsequent to the adjustment of the seat belt height, the current seat belt height or heights for each corresponding seat belt.

By way of example, the means for detecting may, for example, comprise at least one viewing camera disposed at the front of the passenger compartment of the vehicle and oriented towards the back of the passenger compartment of the vehicle.

According to one embodiment, the means for detecting may comprise, for each seat of the vehicle, a dedicated viewing camera disposed facing the corresponding seat.

Advantageously, the at least one viewing camera may be of the time-of-flight type.

According to another embodiment, the means for detecting further comprises, for each seat of the vehicle, a seat belt locking sensor and/or an occupation sensor.

According to yet another aspect, a motor vehicle is provided comprising at least one system such as defined hereinabove.

### BRIEF DESCRIPTION OF THE DRAWINGS

Other advantages and features of the invention will become apparent upon examining the detailed description of non-limiting embodiments and implementations, and from the appended drawings in which:

FIG. 1 illustrates one example of a motor vehicle;

FIG. 2 illustrates schematically one example of an automatic adjustment system for the vehicle;

FIG. 3 illustrates an image taken by a viewing camera;

FIG. 4 illustrates schematically one example of a determination of the coordinate on the axis Z of one element;

FIG. 5 illustrates distances to be measured;

FIGS. 6a-6f illustrate one exemplary operation of an audio adjustment stage;

FIG. 7 illustrates one example of adjustments carried out on seats and seat belts;

FIG. 8 illustrates one example of a method for automatic adjustment of airbags;

FIGS. 9 and 10 illustrate schematically one example of a method for automatic adjustment of rear-view mirrors;

FIG. 11 illustrates one example of a method for adjustment of visibility; and

FIG. 12 illustrates one example of a method for automatic adjustment of the rear-view mirrors.

### DETAILED DESCRIPTION

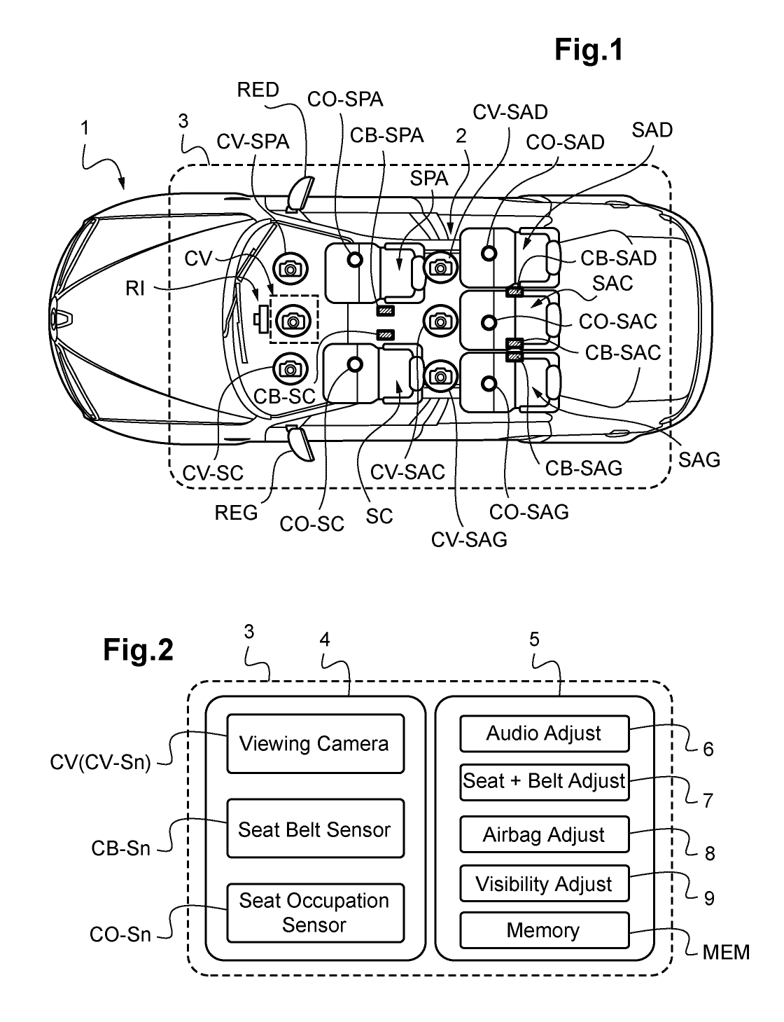

FIG. 1 illustrates one example of a motor vehicle 1, here for example a car 1, comprising, in its passenger compartment 2, front seats, back seats, an interior rear-view mirror RI, a left-hand exterior rear-view mirror REG and a right-hand exterior rear-view mirror RED and a system 3 for automatic adjustment of at least one piece of equipment of the car 1.

The front seats of the car 1 may, for example, comprise a driver's seat SC at least the height of which is electronically controllable, and a front passenger seat SPA.

The back seats of the car 1 may, for example, comprise a left-hand back seat SAG, a central back seat SAC and a right-hand back seat SAD.

It should be noted that it is possible to have several rows of back seats in cars for six or more people. For the purposes of simplification, only examples with cars designed for five people are illustrated.

Reference is now made to FIG. 2 in order to illustrate schematically one example of the automatic adjustment system 3.

The automatic adjustment system 3 comprises means for detecting 4 configured for carrying out a detection of the presence or of the absence of a person on each seat SC, SPA, SAG, SAC, SAD of the car 1 (FIG. 1), and means for adjusting 5 configured for carrying out, as a function of the result of the detection, at least one corresponding automatic adjustment of the at least one piece of equipment of the car 1.

For this purpose, the means for detecting 4 comprise, for example, at least one viewing camera CV, here for example a viewing camera CV of the conventional Time-of-Flight (ToF) type known to those skilled in the art and operating on the time-of-flight principle and allowing a three-dimensional scene to be measured in real time.

In order to have its detection space as large as possible, the viewing camera CV may have a wide angle lens. As illustrated in a dashed-line square in FIG. 1, the camera CV may advantageously be disposed at the front of the passenger compartment 2 of the car 1, here for example by adhesive bonding onto the windscreen of the car 1, and oriented towards the back of the passenger compartment 2 so as to allow the faces of all the persons potentially present in the car 1 to be detected.

As a variant, in order to further improve the quality of the detection of the presence or of the absence of a person on each seat Sn (n=C, PA, AG, AC, or AD) of the car 1, the means for detecting 4 (FIG. 2) may comprise, for each seat Sn of the car 1, a dedicated viewing camera CV-Sn disposed, for example, high up facing each seat Sn, as illustrated in FIG. 1.

In that case, if the face and the eyes of a person occupying this seat Sn are detected by a viewing camera CV-Sn dedicated to this occupied seat Sn and having a detection space focusing in particular on this seat Sn, it is then considered that the person is effectively detected.

For this purpose, algorithms may for example be used that are cited in the open graphics library, known as “OpenCV” and known to those skilled in the art, for detecting the face and the eyes of a person by a viewing camera, for example the following two:
“Method for following eyes” (https://goo.gl/Fw6S04)
“Method for face detection using Haar cascades” (https://goo.gl/XJNRDk)

Although not indispensable, the means for detecting 4 may further comprise (FIG. 1), for each seat Sn of the car 1,

a seat belt attachment sensor CB-Sn known per se and designed to monitor the state of attachment of the corresponding seat belt CS-Sn, and

a seat occupation sensor CO-Sn, here for example one or more pressure detectors known per se and disposed in the corresponding seat Sn.

For this reason, according to the embodiment illustrated in FIG. 1, the means for detecting 4 is configured for determining the presence or the absence of a person on a seat of the car 1 by combining the results of the detections of the dedicated viewing cameras CV-Sn, of the attachment sensors CB-Sn and of the seat presence sensors CO-Sn.

The presence of a person on any given seat Sn of the car 1 can therefore be determined, if for example the results of detection of the corresponding viewing camera CV-Sn, of the corresponding attachment sensor CB-Sn, and of the corresponding seat occupation sensor CO-Sn are jointly positive.

By way of example, in a case where the result of the detection of the viewing camera CV-SPA dedicated to the front passenger seat SPA is negative, whereas the detection results of the corresponding sensors CB-SPA, CO-SPA are positive, the means for detecting 4 is configured for detecting the absence of a person on the front passenger seat SPA.

This case in fact presents a concrete example when a car seat referred to as “back to the road” or rearward facing is installed on the front passenger seat SPA of the car 1.

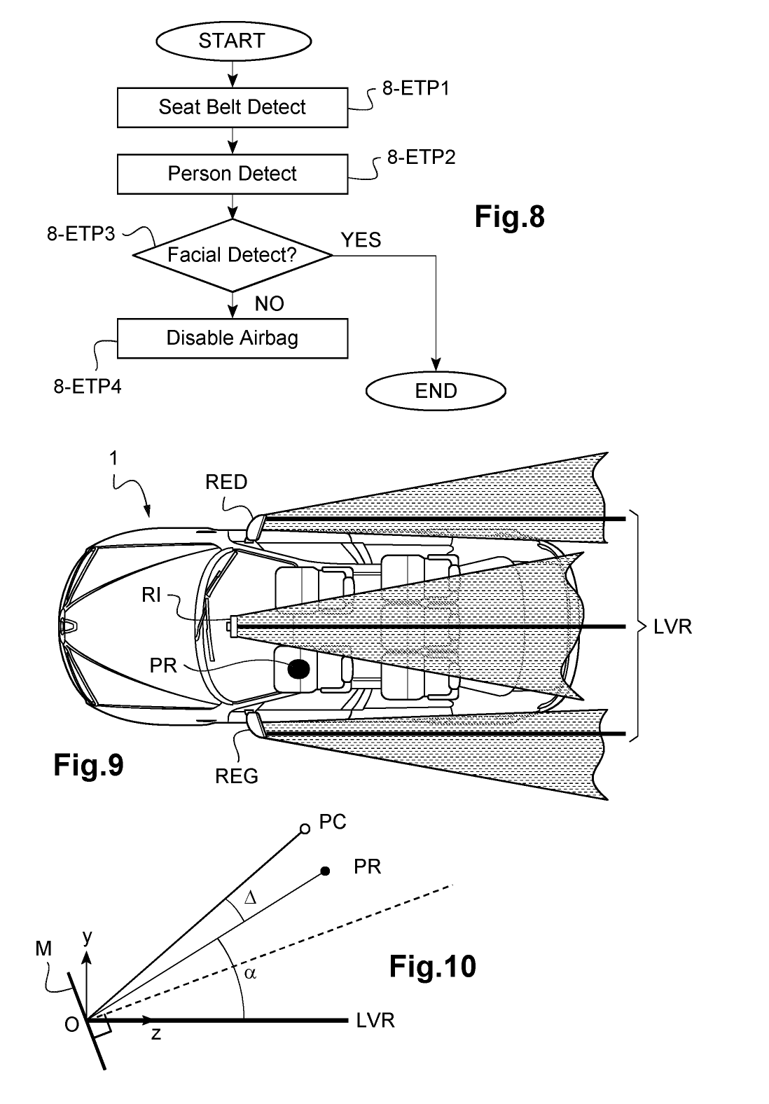

The description of the adjustment of airbags associated with the front passenger seat SPA will be detailed hereinafter with reference to FIG. 8.

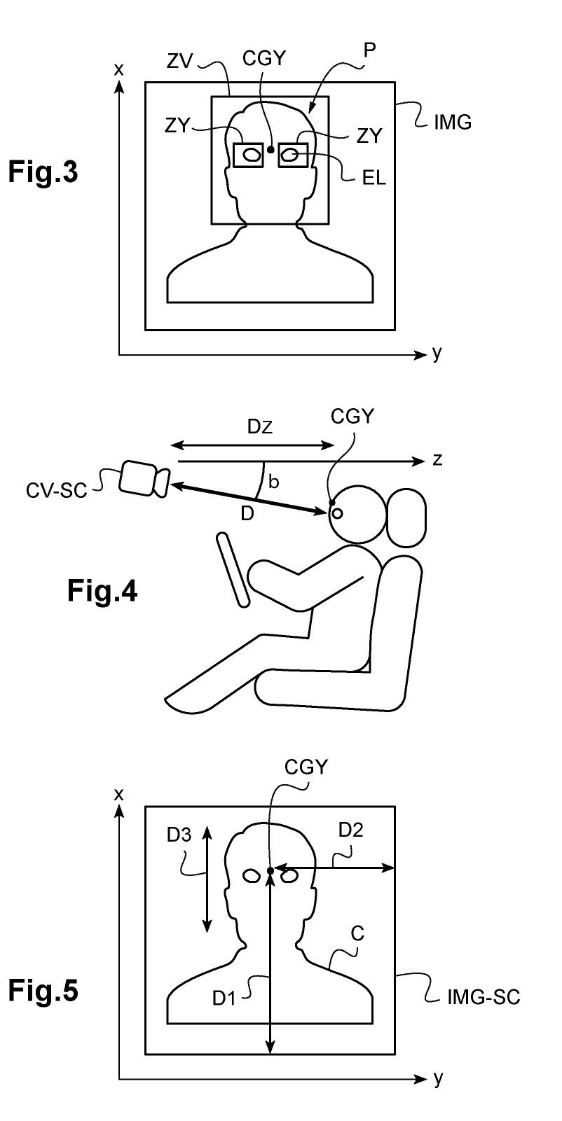

FIG. 3 illustrates an image IMG taken by a viewing camera CV-Sn of the car 1. As has been indicated hereinbefore with the two algorithms mentioned, each viewing camera CV-Sn of the means for detecting 4 is configured for determining, dynamically and precisely, a facial area ZV and areas of the eyes ZY of a person P (FIG. 3) on the corresponding seat Sn of the car 1.

It should be noted that all the viewing cameras CV-SC, CV-SPA, CV-SAG, CV-SAC, CV-SAD are oriented towards the back of the passenger compartment 2 and their positions with respect to the passenger compartment 2 are also known.

Thus, the pixels of the image IMG taken by a viewing camera CV-Sn represent one element EL detected, here for example the left eye of the person, in the passenger compartment 2 by this camera CV-Sn. The coordinates of the element EL in the passenger compartment 2 on the axes X and Y of the image IMG can be calculated.

Once the area of the face ZV and the areas of the eyes ZY of the person P are determined, each viewing camera CV-Sn is configured for detecting the center of gravity of the eyes CGY of the person P.

The center of gravity of the eyes CGY is situated in the middle of the areas of the eyes ZY and its coordinates on the axes X and Y may be calculated based on those of the areas of the eyes ZY.

Reference is now made to FIG. 4 in order to illustrate schematically one example of a determination of the coordinate on the axis Z of one element, here for example the center of gravity of the eyes CGY of the driver, for example by the viewing camera CV-SC dedicated to the driver's seat SC.

By way of example, the axis Z is defined as parallel to the longitudinal direction of the car 1 and the position of the camera CV-SC forms an angle β with respect to the axis Z.

Moreover, the camera CV-SC is configured for detecting the distance D between the position of the camera CV-SC and the center of gravity of the eyes CGY.

Indeed, as for all the other viewing cameras, CV-Sn (n≠C), the viewing camera CV-SC illuminates its detection space, here the passenger compartment 1, and an object to be measured, here the driver C in the car 1, with light radiation, and calculates the time that this light takes to travel the round trip between the driver C and the camera CV-SC. The time of flight of this radiation is directly proportional to the distance D between the camera CV-SC and the driver C.

The camera CV-SC is thus configured for calculating the coordinate Dz along the axis Z of the center of gravity of the eyes CGY based on the distance D and the angle β.

By way of non-limiting example, this calculation of the coordinate Dz may also be carried out by means of a distance sensor as a complement to a non-ToF camera.

FIG. 5 further illustrates distances to be measured on the face V of the driver C by the viewing camera CV-SC for automatic adjustments of the rear-view mirrors RI, REG, and RED which will be detailed hereinafter in the description. It should be noted that FIG. 5 illustrates an image IMG-SC taken by the viewing camera CV-SC.

More precisely, the camera CV-SC is configured for measuring

a first distance D1 between the center of gravity of the eyes CGY of the driver C and the lower limit of the image IMG-SC,

a second distance D2 between the center of gravity of the eyes CGY and a lateral limit of the image IMG-SC, and

a third distance D3 representing the length of the face of the driver C.

Returning now to FIG. 2, the means for adjusting 5 here comprise for example an audio adjustment means 6, a means for adjusting of seats and of seat belts 7, a means for adjusting of airbags 8 and a means for adjusting of visibility 9.

The means for adjusting 5 may, for example, be implemented in the form of software or by means of specific circuits, for example within a microcontroller.

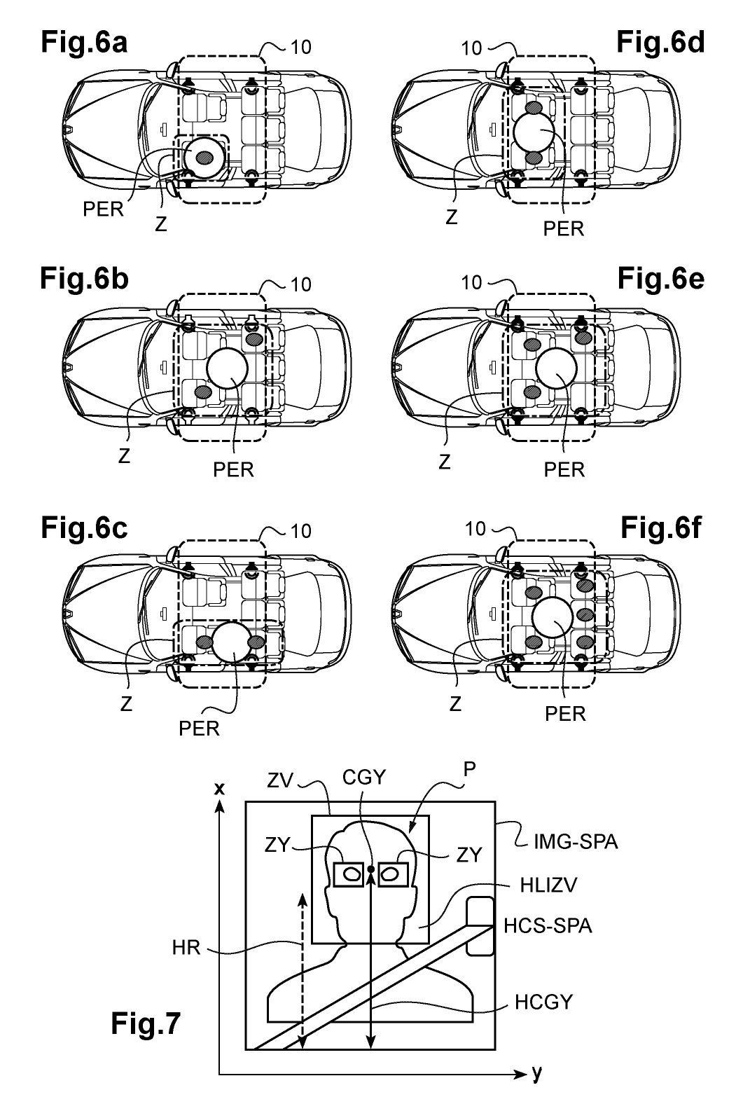

Reference is now made to FIGS. 6a to 6f in order to illustrate one exemplary operation of the audio adjustment means 6.

The car 1 comprises an audio system 10 comprising, here for example, four loudspeakers respectively disposed near to each side door of the car 1.

The audio adjustment means 6 is coupled to the audio system 10 and configured for controlling the audio system 10 in such a manner as to adjust a reference listening position PER (referred to as an “Acoustic Sweet Spot”) known to those skilled in the art and adapted to the presence of the person or persons in the car 1.

It should be noted that this audio adjustment is advantageously carried out in real time by the audio adjustment means 6 taking into account any change in the presence/absence of the persons in the car 1.

In a case illustrated in FIG. 6a, if only one person, here the driver, is present in the car 1, this presence is detected by the means for detecting 4, and the audio adjustment means 6 is configured so as to place the reference listening position PER at the center of a region Z encompassing the driver's seat SC.

If the presence of two persons is detected by the means for detecting 4 (FIGS. 6b to 6d), the audio adjustment means 6 is configured for controlling the audio system 10 in such a manner as to place the reference listening position PER at the center of a region Z encompassing the seats occupied by these persons detected.

By analogy, if there are three (FIG. 6e) or even five persons (FIG. 6f) detected in the passenger compartment 2 by the means for detecting 4, the reference listening position PER of the audio system 10 will be adjusted to the center of a region Z encompassing these seats occupied by these three or five persons present in the passenger compartment, as illustrated in FIGS. 6e and 6f

FIG. 7 illustrates one example of adjustments carried out by the means for adjusting of seats and of seat belts 7 for the driver's seat SC and front passenger seat SPA of the car 1.

The adjustments illustrated in FIG. 7 may also be applied to the back seats if at least one person is detected on at least one of these back seats.

It should be noted that the heights of the driver's seat SC and front passenger seat SPA and of the corresponding seat belts CS-SC or CS-SPA are electronically controllable by the means for adjusting of seats and of seat belts 7.

FIG. 7 illustrates an image taken IMG-SPA by a viewing camera CV-SPA dedicated to one of the front seats, here for example the front passenger seat SPA.

Once the facial area ZV, the areas of the eyes ZY and the center of gravity of the eyes CGY have been detected, the means for adjusting of seats and of seat belts 7 is configured for comparing the height HCGY of the center of gravity of the eyes, in other words the coordinate on the axis X of the center of gravity of the eyes CGY, with a reference height HR, for example predefined by the manufacturer of the car 1 so as to ensure a better visibility towards the front of the car 1.

If the height HCGY of the center of gravity of the eyes and the reference height HR are different, the means for adjusting 7 is configured for adjusting the height of the corresponding seat H-SPA in such a manner as to render it substantially equal to the reference height HR. The positions of the area of the face ZV and of the areas of the eyes ZY are accordingly modified.

It should be noted that the manufacturer of the car 1 may, for example, predetermine at least one tolerance during the calibration of the car in order to take into account any potential offset between the seats Sn of the car 1 and the corresponding seat belts.

Then, the means for adjusting of seats and of seat belts 7 is configured so as to adjust the height of the seat belt of the front passenger seat CS-SPA in order to render substantially equal the height of the corresponding seat belt HC-SPA and the height HLIZV of the lower limit of the area of the face ZV obtained subsequent to the adjustment in height of the corresponding seat SPA.

Accordingly, the driver or the front passenger can obtain the heights of the corresponding seat SC or SPA and of the corresponding seat belt CS-C or CS-SPA that are adapted to them and a better visibility towards the front of the car 1.

It should be noted that the driver or the front passenger can still make manual adjustments later on and this automatic adjustment of seats and of seat belts may also be disabled at any time.

Reference is now made to FIG. 8 in order to illustrate one example of a method for automatic adjustment of airbags carried out by the means for adjusting of airbags 8. It should be noted that the airbags CG-SPA associated with the front passenger seat SPA are all enabled by default.

Following the start up of the system 3, in a first step 8-ETP1, the means for detecting 4 detect whether the seat belt CS-SPA of the front passenger seat is attached.

In the affirmative, the means for detecting 4 are subsequently configured for enabling the corresponding viewing camera CV-SPA so as to detect the presence or absence of a person on the front passenger seat SPA (8-ETP2).

In the third step 8-ETP3, if the presence of a person is detected, in other words the facial area ZV and the areas of the eyes of this person are detected by the camera CV-SPA, the method ends and the airbags for the front passenger seat CG-SPA remain enabled.

In the opposite case, the means for adjusting of airbags 8 is configured for disabling all the airbags associated with the front passenger seat CG-SPA (8-ETP4).

It is important to note that the driver will preferably always be informed of this disabling, for example by a message on a display means of the car 1, and they can always cancel this automatic disabling feature if they wish.

Otherwise, after a period of time, the airbags CG-SPA could be automatically disabled by the means for adjusting of airbags 8. In one safety aspect, it is preferable to require a response from the driver in order to ensure that the driver really is aware of this disabling.

FIGS. 9 and 10 illustrate schematically one example of a method for automatic adjustment of rear-view mirrors carried out by the means for adjusting of visibility 9.

FIG. 9 shows a reference position PR of the driver—more precisely, a reference position PR of the center of gravity of the eyes CGY of the driver, defined for example by the manufacturer of the car 1.

The rear-view mirrors RI, REG and RED of the car 1 are accordingly adjusted into reference orientations so as to provide a better visibility, both internally and externally, towards the back of the car 1. FIG. 9 illustrates, in this respect, three reference lines of view LVR for these three rear-view mirrors RI, REG and RED.

It should be noted that the interior RI and exterior REG and RED rear-view mirrors of the car 1 are advantageously controllable in orientation; in other words, they are controllable in both altitude and azimuth.

As a general rule, the various adjustments of the rear-view mirrors with respect to the reference position PR are carried out in a similar manner. For the purposes of simplification, only one adjustment of a rear-view mirror in azimuth is presented with reference to FIG. 10. It is also assumed that the current position PC of the center of gravity of the eyes CGY and the reference position PR are at the same height (axis X).

The reference M in FIG. 10 represents a mirror M of any of the rear-view mirrors. The origin O of the system of coordinates Z and Y represents the azimuthal axis of rotation of the mirror M.

An angle α is formed between the reference position PR and the reference line of view LVR and an angle Δ is formed between the current position PC and the reference position PR.

Once the coordinates on the axes Y and Z of the positions PR and PC are known, the means for adjusting of visibility 9 is configured for calculating the angle Δ by applying for example the well-known theorem of Al-Kashi.

As the angle α is predefined by the manufacturer of the car 1, the angle formed between the current position and the reference line of view LVR may be calculated by combining the angles α and Δ.

The means for adjusting of visibility 9 is configured for setting a new orientation of the mirror M, being perpendicular to the bisector of the angle α+Δ.

As a variant, the means for adjusting of visibility 9 further comprises a memory MEM (FIG. 1) configured for storing new positions of the rear-view mirrors RI, REG, RED of the car 1 for a saved driver profile.

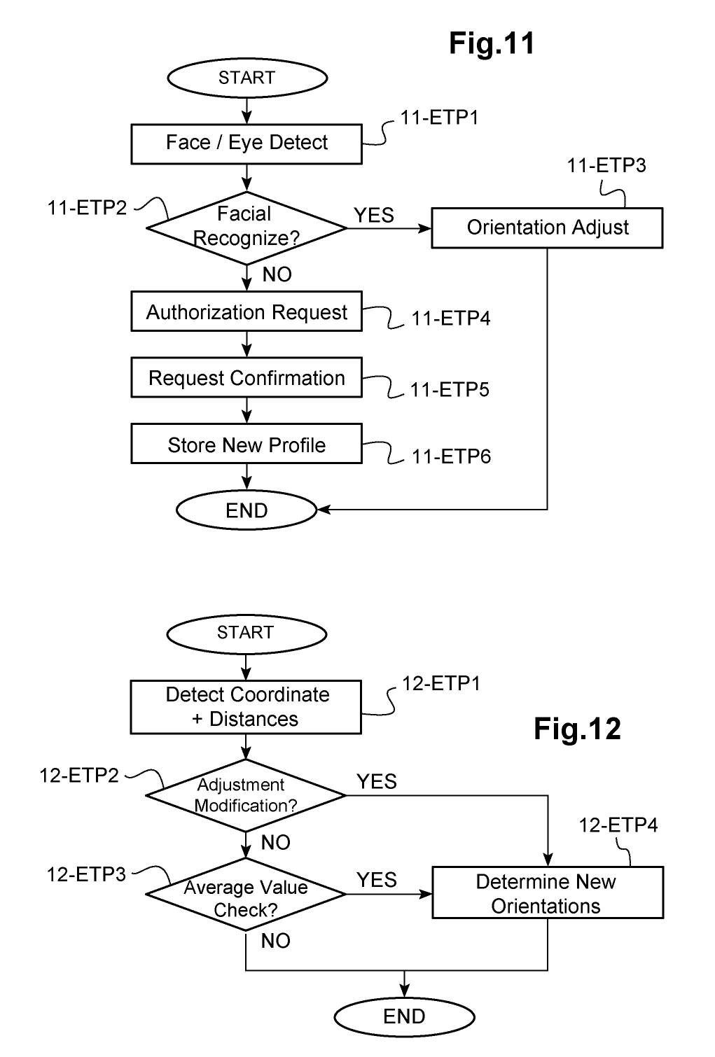

Reference is now made to FIG. 11 in order to illustrate one example of a method for adjustment of visibility prior to starting the car 1.

The method begins with a first step 11-ETP1 comprising a detection of the facial area ZV, of the areas of the eyes ZY and of the current position PCCGY of the center of gravity of the eyes of the driver, and then a second step 11-ETP2 comprising a facial recognition RF on the detected area of the face ZV of the driver using a comparison with profiles PE of drivers saved in the memory MEM.

In the case of a successful recognition, the means for adjusting of visibility 9 is configured for adjusting the orientations of the rear-view mirrors RI, REG, RED of the car 1 according to the data saved in the saved profile PE of this driver (11-ETP3).

In the case of a recognition failure, the means for adjusting of visibility 9 is configured for requesting the authorization of the driver in order to carry out the adjustments of the rear-view mirrors RI, REG, RED (11-ETP4). The driver may, for example, authorize this by simply putting their hands on the steering wheel or by a vocal confirmation via a voice recognition system.

After the detection of the new orientations of the rear-view mirrors RI, REG, RED adapted to the driver, the means for adjusting of visibility 9 is further configured (11-ETP5) for requesting a confirmation by the driver so as to validate these new orientations. In the case where they are not satisfied, the driver can always carry out conventional manual adjustments of the rear-view mirrors RI, REG, RED of the car 1.

In the case where the driver agrees, the memory MEM is configured so as to create, in the following step 11-ETP6, a new profile NP for this driver and to store these new orientations, set by the means for adjusting of visibility 9 or by the manual adjustments carried out by the current driver, in the profile saved for the current driver.

FIG. 12 illustrates one example of a method for automatic adjustment of the rear-view mirrors RI, REG, RED when the car 1 is in motion.

In the first step 12-ETP1 of this method, the means for detecting 4 is configured for detecting the coordinate Dz along the axis Z of the center of gravity of the eyes CGY of the driver of the car 1, and the first, second and third distances D1 to D3, illustrated in FIGS. 4 and 5.

The means for detecting 4 are subsequently configured for detecting (12-ETP2) whether there is a modification on the adjustments of the driver's seat SC.

In the case of no modification, the means for detecting 4 is further configured for detecting (12-ETP3) whether the average values of the coordinate Dz, and of the first, second and third distances D1 to D3 are modified and remain stable for at least N seconds, here for example 30 seconds.

If the results of the detections 12-ETP2 and 12-ETP3 are all negative, the method ends.

In the opposite case, in other words if the result of at least one of the two detections 12-ETP2 and 12-ETP3 is positive, the means for adjusting of visibility 9 is configured for determining new orientations NP of the rear-view mirrors RI, REG, RED adapted to the current position PCCGY of the center of gravity of the eyes of the driver in the passenger compartment 2 so as to allow a better visibility towards the back of the car 1 to be dynamically obtained.

By analogy, the facial recognition may, for example, also be carried out via each camera CV-Sn dedicated to each seat Sn by using the memory MEM, when at least one person P is detected on at least one seat Sn of the car 1 and the heights of all the seats and of all the seat belts are adjustable.

In the case of a successful recognition, the means for adjusting of seats and of seat belts 7 is configured for carrying out:

the adjustment of the seat height with the height or heights of at least one seat Sn of the car 1 stored in the memory MEM and associated with the at least one person P, and

the adjustment of the seat belt height with the height or heights of at least one seat belt HC-Sn stored in the memory MEM and associated with the at least one person P.

In the case of a recognition failure, the memory MEM is configured for storing:

subsequent to the adjustment of the seat height, the current seat height or heights (H-Sn) for each occupied seat (Sn) of the vehicle (1), and for storing

subsequent to the adjustment of the seat belt height, the current seat belt height or heights (HC-Sn) for each corresponding seat belt (CS-Sn).

1. A method for automatic adjustment of at least one piece of equipment of a motor vehicle, comprising:
detecting a presence of at least one person on at least one seat of the motor vehicle or of an absence of a person on a front passenger seat of the motor vehicle; and
at least one automatic adjusting of the at least one piece of equipment as a function of a result of the detecting.

2. The method according to claim 1, wherein, if presence of at least one person on at least one seat of the motor vehicle is detected, the at least one adjusting comprises an automatic adjusting of an audio configuration of an audio system of the motor vehicle depending on the at least one seat occupied by the at least one person that is detected.

3. The method according to claim 2, wherein the automatic adjusting of the audio configuration comprises adjusting a reference listening position of the audio system of the motor vehicle in such a manner as to place the reference listening position at a center of a region encompassing the seat or seats occupied by detected at least one person.

4. The method according to claim 1, wherein, if the presence of at least one person on at least one seat of the motor vehicle is detected, the method further comprises:
determining areas of a face and of eyes of the detected person or persons on the corresponding occupied seat or seats; and
wherein the at least one adjusting comprises automatically adjusting a height of a corresponding occupied seat or seats and/or of corresponding seat belt or seat belts.

5. The method according to claim 4, wherein automatically adjusting the height comprises:
performing a first adjustment of the height of each corresponding occupied seat, and
then performing a second adjustment of the height of each corresponding seat belt.

6. The method according to claim 5, wherein:
performing the first adjustment comprises first adjusting the height of each corresponding occupied seat so as to render substantially equal a height of a center of an area of the eyes of the corresponding person and a reference height; and
performing the second adjustment comprises second adjusting the height of each corresponding seat belt so as to render substantially equal the height of the corresponding seat belt and the height of a lower limit of the facial area of the corresponding person.

7. The method according to claim 1, wherein, if the absence of a person on the front passenger seat is detected, the at least one automatic adjusting comprises:
disabling an airbag or airbags associated with the front passenger seat.

8. The method according to claim 1, wherein, if the presence of a person on the driver's seat is detected, the method further comprises:
determining areas of the face and of the eyes of the person on the driver's seat in such a manner as to determine the current position of the eyes of this person; and
wherein the at least one adjusting comprises performing a third adjustment of rear-view mirrors of the motor vehicle as a function of the current position of the eyes.

9. The method according to claim 8, wherein performing the third adjustment comprises adjusting orientations of the rear-view mirrors of the vehicle as a function of an angular difference between the current position of the eyes and a reference position.

10. The method according to claim 8, further comprising:
performing a facial recognition of the person detected on the driver's seat; and
in case of a successful facial recognition, performing the third adjustment using stored orientations of the rear-view mirrors of the vehicle associated with the facially recognized person; and
in the case of a failed facial recognition, performing at least one adjustment by storing current orientations of the rear-view mirrors of the vehicle subsequent to performing the third adjustment.

11. The method according to claim 10, wherein performing the third adjustment comprises adjusting orientations of the rear-view mirrors of the vehicle as a function of an angular difference between the current position of the eyes and a reference position.

12. The method according to claim 5, further comprising:
performing a facial recognition of at least one person detected on at least one seat of the vehicle; and
in the case of a successful facial recognition, performing the first adjustment using stored seat height or heights associated with the at least one person, and performing the second adjustment using stored seat belt height or heights associated with the at least one person; and
in the case of a failed facial recognition, performing the at least one adjustment comprises storing current seat height or heights of each occupied seat of the vehicle and a storing current seat belt height or heights for each corresponding seat belt.

13. A system for automatic adjustment of at least one piece of equipment of a motor vehicle, comprising:
means for detecting a presence of at least one person on at least one seat of the motor vehicle or an absence of a person on the front passenger seat of the motor vehicle; and
means for making at least one automatic adjustment of the at least one piece of equipment as a function of a result of the means for detecting.

14. The system according to claim 13, wherein the means for adjusting comprises an audio adjustment means configured, if the means for detecting detect the presence of at least one person on at least one seat of the vehicle, for automatically adjusting an audio configuration of an audio system of the motor vehicle depending on the seat or seats occupied by the person or persons detected.

15. The system according to claim 14, wherein the audio adjustment means is configured for automatically adjusting the audio configuration of the audio system of the vehicle by adjusting a reference listening position of the audio system of the motor vehicle in such a manner as to place a reference listening position at the center of a region encompassing the seat or seats occupied by the person or persons detected.

16. The system according to claim 13, further including means, if the means for detecting detects the presence of at least one person on at least one seat of the vehicle, for determining areas of the face and of the eyes of the person or persons on the corresponding occupied seat or seats; and
wherein the means for adjusting further comprises means for adjusting heights of seats and seat belts in response to the determined face and eyes.

17. The system according to claim 16, wherein the means for adjusting automatically adjusts the height or heights of the corresponding occupied seat or seats and of the corresponding seat belt or seat belts using:
a first adjustment of the height of each corresponding occupied seat; and
then a second adjustment of the height of each corresponding seat belt.

18. The system according to claim 17, wherein the means for adjusting seats and seat belts is further configured to:
carry out the first adjustment by a first adjustment of the height of each corresponding occupied seat so as to render substantially equal the height of the center of the area of the eyes of the corresponding person and a reference height; and
carry out the second adjustment by a second adjustment of the height of each corresponding front seat belt so as to render substantially equal the height of the corresponding seat belt and the height of the lower limit of the facial area of the corresponding person.

19. The system according to claim 13, wherein the means for adjusting further comprise means for adjusting airbags by, if the means for detecting detects the absence of a person on the front passenger seat, disabling one or more airbags associated with the front passenger seat.

20. The system according to claim 16, further comprising means, if the means for detecting detects the presence of a person on the driver's seat, for determining areas of the face and of the eyes of the person on the driver's seat in such a manner as to determine the current position of the eyes of this person; and
wherein the means for adjusting performs a visibility adjustment configured to carry out a third adjustment of rear-view mirrors of the vehicle as a function of the current position of the eyes.

21. The system according to either of claim 20, wherein the means for adjusting performs an adjustment of orientations of the rear-view mirrors of the vehicle as a function of an angular difference between the current position of the eyes and a reference position.

22. The system according to claim 13, further comprising a memory configured for storing a driver profile, wherein the means for detecting is further configured to perform a facial recognition of the person detected on the driver's seat using the memory; and wherein, in the case of a successful facial recognition, the means for adjusting performs an adjustment of orientations of rear-view mirrors of the motor vehicle in accordance with the driver profile stored in the memory of the facially recognized person and, in the case of a failure of the facial recognition, further storing in the memory current orientations of the rear-view mirrors of the vehicle.

23. The system according to either of claim 22, wherein the means for adjusting performs an adjustment of orientations of the rear-view mirrors of the vehicle as a function of an angular difference between the current position of the eyes and a reference position.

24. The system according to claim 13, further comprising means for carrying out a facial recognition of at least one person detected on at least one seat of the vehicle using the memory; and further comprising:
means, in the case of a successful facial recognition, for adjusting seats and seat belts with a height or heights of at least one seat of the vehicle stored in a memory and associated with the facially recognized person and, in the case of a failed facial recognition failure, for storing in the memory current seat height or heights of each occupied seat of the vehicle and storing in the memory current seat belt height or heights for each corresponding seat belt.

25. The system according to claim 13, wherein the means for detecting comprises at least one viewing camera disposed at a front of the passenger compartment of the motor vehicle and oriented towards a back of the passenger compartment of the motor vehicle.

26. The system according to claim 25, wherein the at least one viewing camera is of a time-of-flight type camera.

27. The system according to claim 13, wherein the means of detection comprises, for each seat of the vehicle, a dedicated viewing camera disposed facing the corresponding seat.

28. The system according to claim 27, wherein the at least one viewing camera is of a time-of-flight type camera.

29. The system according to claim 13, wherein the means for detecting comprises, for each seat of the vehicle, a seat belt locking sensor and/or a seat occupation sensor.
